(19) United States
(12) Patent Application Publication
(10) Pub. No.: US 2005/0027807 A1
(43) Pub. Date: Feb. 3, 2005

(54) Systems and methods for facilitating peripheral device firmware installation

(76) Inventors: Lynda Fengler, Meridian, ID (US); Kristen L. Bhatti, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/630,461

(22) Filed: Jul. 30, 2003

(51) Int. Cl. G06F 15/16; G06F 13/00; G06F 9/445

(52) U.S. Cl. 709/206; 719/321; 717/174

(57) ABSTRACT

Disclosed are systems and methods for facilitating peripheral device firmware installation. In one embodiment, a system and a method pertain to transmitting a firmware availability notification, receiving a firmware download request, and transmitting a firmware file to a peripheral device for installation on the peripheral device. In another embodiment, a system and a method pertain to receiving a firmware availability notification with a peripheral device, and providing a related notification to a user, the related notification being provided by the peripheral device.

### BACKGROUND

Peripheral devices such as printers, copiers, scanners, and the like, typically comprise firmware that includes programmatic instructions that are executed to control operation of the devices. From time to time, new versions of such firmware are released, for instance to correct previous glitches or to improve device performance in some manner (e.g., in terms of quality and/or speed).

Often, new firmware, in the form of firmware updates, is available for installation on existing peripheral devices that comprise older versions of such firmware. However, firmware updates are not readily available to the typical peripheral device user. Unlike as with software upgrades intended for installation on a user computer device such as a personal computer (PC), the availability of peripheral device firmware updates is not often communicated to such users. In fact, a user normally will only become aware of such an update upon speaking with a customer service representative for the device manufacturer after encountering an error with the operation of the peripheral device.

Even when the availability of such firmware is communicated to the device user, the user may not be prepared to install it. For instance, depending upon the particular peripheral device at issue, new firmware may only be installable by replacing a circuit board (e.g., formatter board) of the peripheral device. Often, such a task is performed by a professional repairperson on a service call. In cases in which firmware can be installed without such board replacement, the user must still locate the firmware upgrade file or files and determine how to install the file(s). That task may be difficult for several users, especially if they are not particularly computer-savvy.

### SUMMARY OF THE DISCLOSURE

Disclosed are systems and methods for facilitating peripheral device firmware installation. In one embodiment, a system and a method pertain to transmitting a firmware availability notification, receiving a firmware download request, and transmitting a firmware file to a peripheral device for installation on the peripheral device.

In another embodiment, a system and a method pertain to receiving a firmware availability notification with a peripheral device, and providing a related notification to a user, the related notification being provided by the peripheral device.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which the availability of peripheral device firmware can be communicated to a device user and with which the firmware can be installed on the device.

FIG. 2 is a block diagram of an embodiment of a network-accessible computing device shown in FIG. 1.

FIG. 3 is a block diagram of an embodiment of a peripheral device shown in FIG. 1.

FIG. 4 is a flow diagram that illustrates an embodiment of a method for providing notification as to peripheral device firmware and for installing the firmware.

FIG. 5 is a flow diagram that illustrates an embodiment of operation of a firmware service, shown in FIG. 2, in registering a peripheral device and peripheral device user.

FIG. 6 is a flow diagram that illustrates an embodiment of operation of the firmware service, shown in FIG. 2, in notifying a user as to the availability of firmware and in facilitating firmware installation.

FIG. 7 is a flow diagram that illustrates an embodiment of operation of a peripheral device, shown in FIG. 3, in receiving notification of firmware and installing the firmware.

### DETAILED DESCRIPTION

As described above, peripheral device users often may not be aware of the availability of firmware for use with a peripheral device, and further may not be able to install it. As is described in the following, however, users can be alerted as to the availability of such firmware by providing the users with firmware availability notifications. In addition, installation of the firmware on the peripheral device can be facilitated to, at least partially, automate the installation process for the users.

Disclosed herein are embodiments of systems and methods for facilitating peripheral device firmware installation. Although particular embodiments are disclosed, these embodiments are provided for purposes of example only to facilitate description of the disclosed systems and methods.

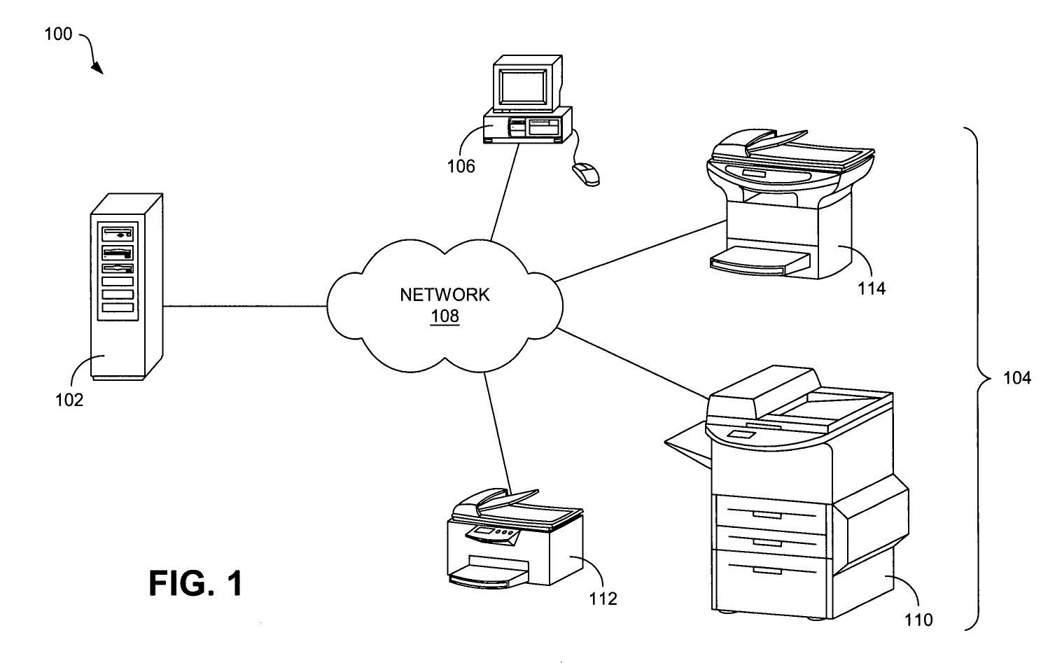

Referring now in more detail to the drawings, in which like numerals indicate corresponding parts throughout the several views, FIG. 1 illustrates an example system 100. As indicated in that figure, the system 100 generally comprises a network-accessible computing device 102, one or more peripheral devices 104, and a user computing device 106, each of which is connected to a network 108.

The network-accessible computing device 102 can comprise, for example, a network server, such as a web server, that hosts a firmware service that both notifies users of available peripheral device firmware and facilitates installation of such firmware. By way of example, the network-accessible computing device 102 is operated by or on behalf of the peripheral device manufacturer or firmware developer.

The peripheral devices 104 are devices of the type that are peripheral to a computing device, such as personal computer (PC) and/or that are available for walk-up use. By way of example, the peripheral devices 104 each comprise a printing device that is capable of generating hard copy documents from data that is transmitted to and/or collected by the device. In the example system configuration shown in FIG. 1, the peripheral devices 104 are printing devices including a printer 110, a photocopier 112, and a multi-function peripheral (MFP) device 114 which is capable of performing multiple tasks such as printing, copying, scanning, faxing, and emailing. Although particular peripheral devices 104 are shown in FIG. 1, the peripheral devices of the system 100 may comprise any device on which firmware may be installed and that is connectable to the network 108.

The user computing device 106 is a local computer that, for instance, shares a local area network (LAN) with the peripheral devices 104. In the example of FIG. 1, the user computing device 106 is a personal computer (PC). Although a PC is shown in FIG. 1 and has been identified herein, the user computing device 106 could, alternatively, comprise another type of computer including, for instance, a Macintosh™ computer, a notebook computer, or other computing device that is capable of communicating with the network-accessible computing device 102 and/or the peripheral devices 104. Optionally, the user computing device 106 may comprise a software program that is used to control and administer each of the peripheral devices 104 on a given network (e.g., LAN).

The network 108 normally comprises multiple sub-networks that are communicatively coupled to each other. By way of example, the network 108 comprises one or more wide area networks (WANs) and LANs, and further comprises part of the Internet.

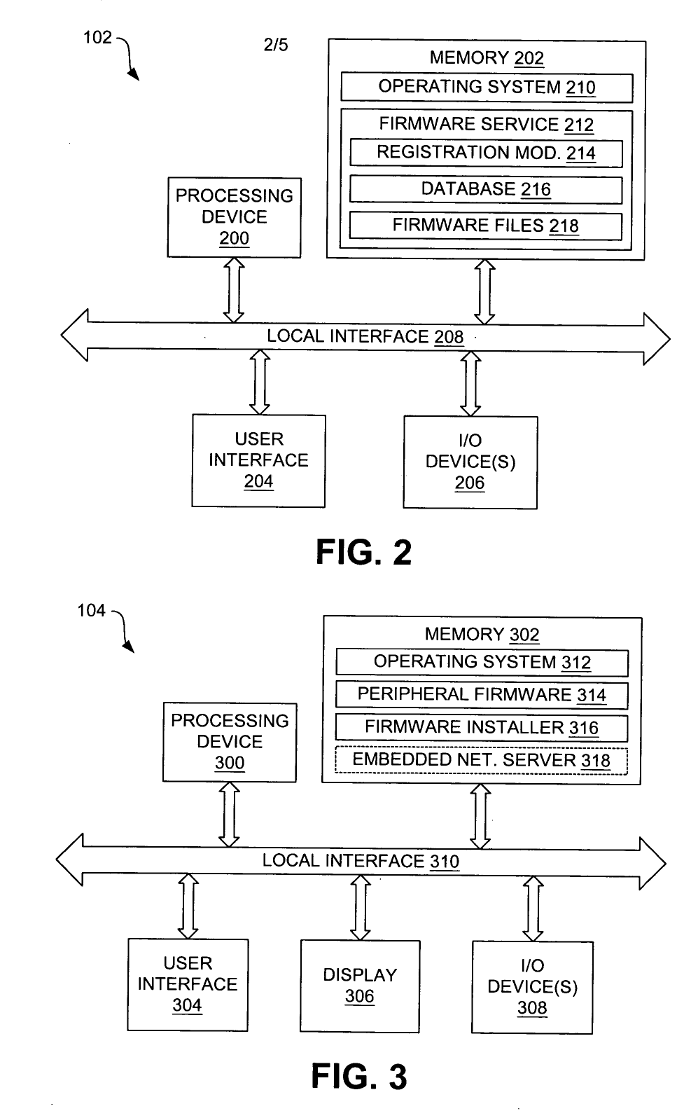

FIG. 2 is a block diagram illustrating an example architecture for the network-accessible computing device 102 shown in FIG. 1. As indicated in FIG. 2, the network-accessible computing device 102 comprises a processing device 200, memory 202, a user interface 204, and at least one I/O device 206, each of which is connected to a local interface 208.

The processing device 200 can include a central processing unit (CPU) or an auxiliary processor among several processors associated with the network-accessible computing device 102, or a semiconductor based microprocessor (in the form of a microchip). The memory 202 includes any one of or a combination of volatile memory elements (e.g., RAM) and nonvolatile memory elements (e.g., hard disk, read only memory (ROM), tape, etc.).

The user interface 204 comprises the components with which a user interacts with the network-accessible computing device 102, such as a keyboard and mouse, and a device that provides visual information to the user, such as a cathode ray tube (CRT) or liquid crystal display (LCD) monitor.

With further reference to FIG. 2, the one or more I/O devices 206 are adapted to facilitate network-based communications and therefore include one or more communication components such as a modulator/demodulator (e.g., modem), wireless (e.g., (RF)) transceiver, a telephonic interface, a bridge, a router, etc.

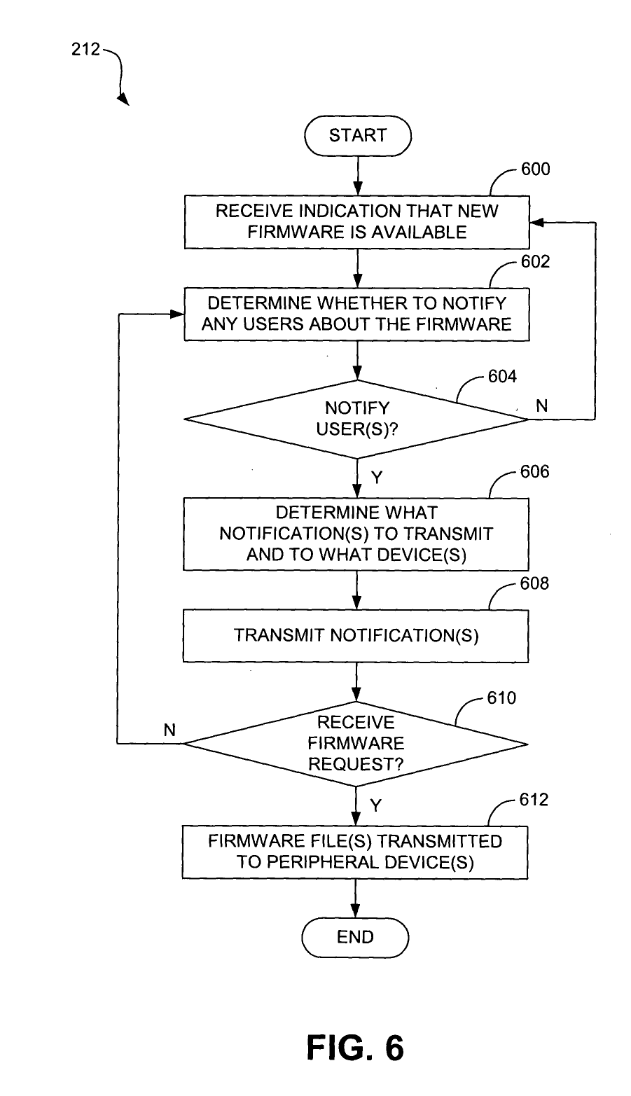

The memory 202 comprises various programs including an operating system 210 and a firmware service 212. The operating system 210 controls the execution of other programs and provides scheduling, input-output control, file and data management, memory management, and communication control and related services. The firmware service 212 is configured to notify users when peripheral device firmware is available for installation and to facilitate such installation, when users so desire. As indicated in FIG. 2, the firmware service 212 can include a registration module 214 that is used to register users and their peripheral devices with the service, a database 216 that is used to store the collected information as to the registered users/devices, and firmware files 218 that are available for download and installation. The firmware files 218 can comprise firmware patches that correct glitches of previous firmware versions, firmware updates that may comprise improved (e.g., in terms of print quality and/or performance) firmware, as well as specialized firmware that optimizes peripheral device operation in some manner. Operation of the firmware service 212 is described in greater detail below in relation to FIGS. 5 and 6.

FIG. 3 is a block diagram illustrating an example architecture for the peripheral devices 104 shown in FIG. 1. As indicated in FIG. 3, each peripheral device 104 comprises a processing device 300, memory 302, a user interface 304, a display 306, and at least one input/output (I/O) device 308. Each of these components is connected to a local interface 310 that, by way of example, comprises one or more internal buses.

The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the peripheral device 104. The memory 302 comprises any one or a combination of volatile memory elements (e.g., random access memory (RAM)) and nonvolatile memory elements (e.g., read-only memory (ROM), Flash memory, hard disk, etc.).

The user interface 304 comprises the tools with which the device settings can be changed and through which the user can communicate commands to the peripheral device 104. By way of example, the user interface 304 comprises one or more function keys and/or buttons contained within a device control panel. In such a case, the display 306 typically also is provided in the control panel. The display 306 is configured to present visual information to the user, such as firmware notifications that pertain to notifications received from the firmware service 212 (FIG. 2), and may comprise a liquid crystal display (LCD) or light emitting diode (LED) display.

The one or more I/O devices 308 facilitate communications with other devices over the network 108, such as the network-accessible computing device 102 and the local computing device 106, and therefore may include a modulator/demodulator (e.g., modem), network card, wireless (e.g., RF) transceiver, or other such communication component.

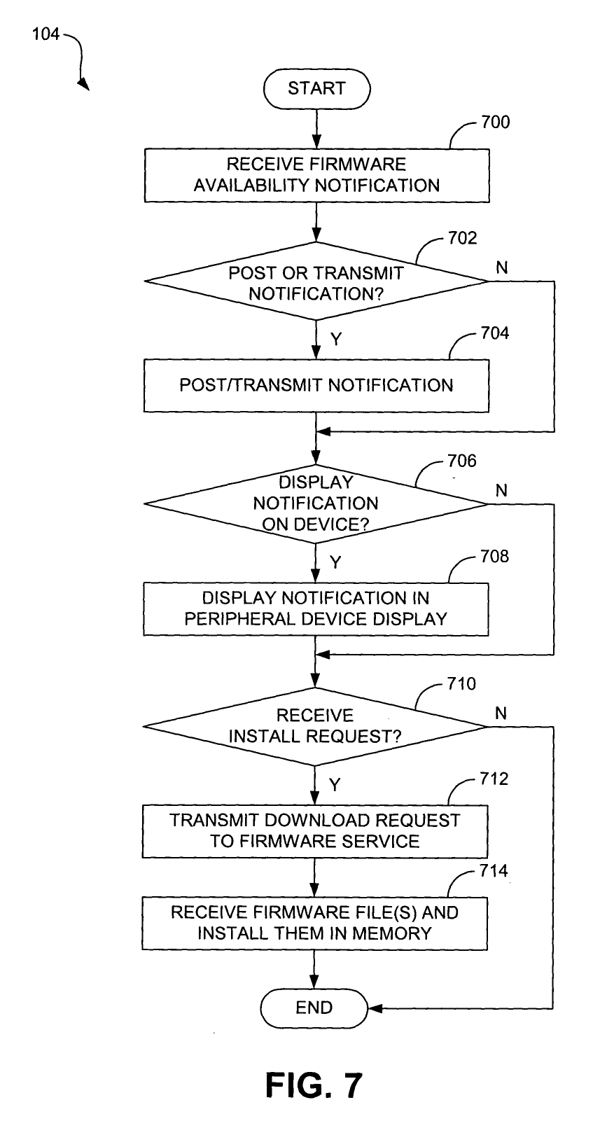

The memory 302 includes various programs, for instance in firmware, including an operating system 312, peripheral firmware 314 that is used to perform the various tasks for which the peripheral device is configured (e.g., printing, copying, scanning, etc.), and a firmware installer 316 that, as is described below, is configured to receive and install firmware. Optionally, the peripheral device memory 302 further includes an embedded network (e.g., web) server 318 that is configured to post and/or transmit firmware notifications. Operation of the peripheral device 104 associated with notifying a user as to the availability of firmware and installing such firmware is discussed in relation to FIG. 7.

Various programs have been described herein. These programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

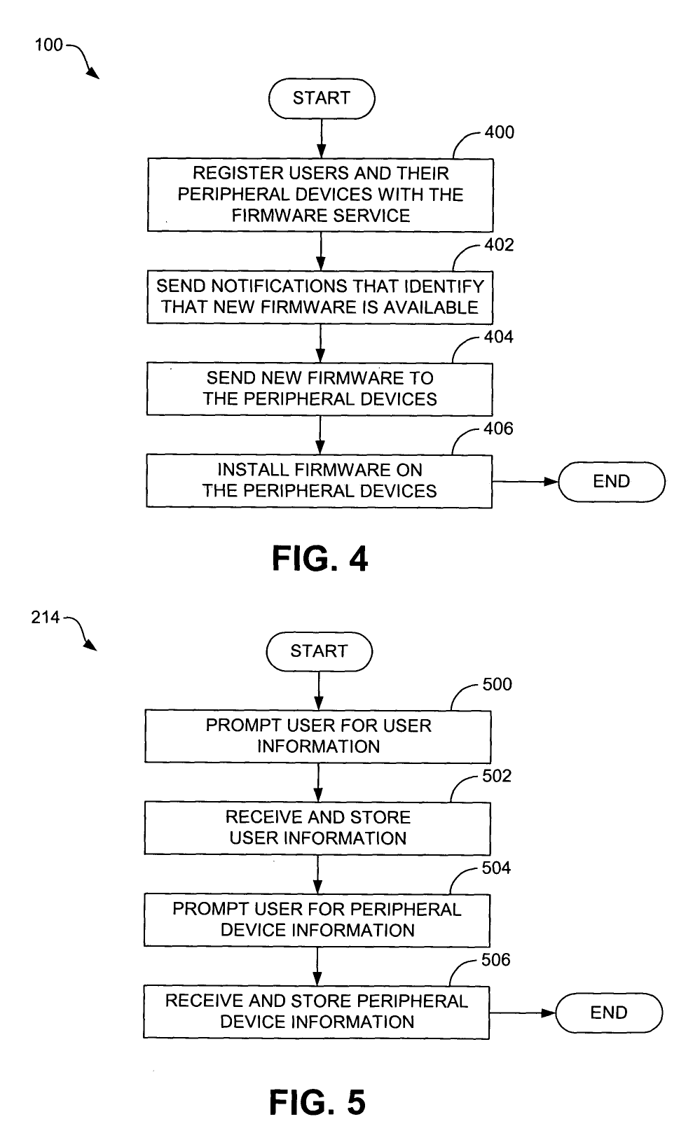

Embodiments of the invention may be used to notify users when new firmware is available for installation on given peripheral devices, as well as to facilitate the installation of the firmware when so desired by the users of the peripheral devices. An example method for such notifying and facilitating is described in relation to FIG. 4. Beginning with block 400 of FIG. 4, the system 100 registers users and their peripheral devices with the firmware service so as to enable notification and firmware installation facilitation as to those users and devices. Through the registration process various information about the users and their peripheral devices is collected including, for example, user identifications, user email addresses, peripheral device model identifications, identifications of associated sub-devices that the peripheral devices comprise, and identifications as to the firmware versions that the peripheral devices and/or their associated sub-devices execute.

When new firmware becomes available for registered peripheral devices, notifications that identify the availability of this firmware are sent, as indicated in block 402. As is described in greater detail below, the notifications can be sent to the users and/or to the peripheral devices. Once the users receive the notifications (either directly or by seeing a notification provided by the peripheral devices), the users can determine whether they wish to install the firmware. If so, the new firmware is sent to the peripheral devices, as indicated in block 404, and, as indicated in block 406, the new firmware is installed on the peripheral devices.

FIG. 5 provides an example of operation of the firmware service 212, and more particularly the registration module 214 of the firmware service, in registering users and their peripheral devices. By way of example, this registration process can be facilitated via network communications. More particularly, registration can be achieved via the World Wide Web by collecting registration information using one or more web pages that prompt the user for the information. Beginning with block 500, the registration module 214 prompts the user for user information. In cases in which the information is collected using one or more web pages, this prompting can be effected by providing various data entry fields on the web page(s).

By way of example, the user information can comprise information as to the user identity (e.g., name), user address, user telephone number, and user email address. In addition, the user information can include information as to user notification preferences. For instance, the preferences information can include information as to the types of firmware about which the user would like to be notified (e.g., a preference to be notified as to firmware patches that correct firmware glitches but not to be notified as to specialized firmware), information as to the manner in which the user would like to be notified (e.g., via the peripheral device display or via an email message), and so forth. Furthermore, the user information can, optionally, comprise payment information, such as credit card account information, that may be used to purchase firmware (e.g., specialized firmware) that the firmware service 212 does not provide for free.

With reference to block 502, once or as the user information is provided, the user information is received and stored by the registration module 214, for example in the firmware service database 216. Next, the registration module 214 prompts the user for peripheral device information, as indicated in block 504. Depending upon the circumstances, the user may be prompted for information about multiple peripheral devices, for instance, if the user is a system administrator that is responsible for all of the peripheral devices on a given LAN. The user may be prompted for various information regarding the peripheral device(s) including, for example, the peripheral device models, the peripheral device serial numbers, the peripheral device media access control (MAC) addresses, the peripheral device network addresses (e.g., universal resource locators (URLs)), the firmware versions each peripheral device runs, the sub-devices that are used by the peripheral devices (e.g., paper input devices, paper processing devices (e.g., stapling devices, folding devices) and the firmware versions they run, etc.

Once or as this information is provided, the peripheral device information is received and stored, as indicated in block 506. Again, this information can be stored in the firmware service database 216. From the user information and the peripheral device information, the firmware service 212 can determine what notifications to send about which firmware and to what devices.

After registration has been completed, firmware notifications can be sent to the registered user/devices as new firmware becomes available, and the new firmware can be installed, if desired. FIG. 6 provides an example of operation of the firmware service 212 in providing such notification and facilitating firmware installation. Beginning with block 600 of FIG. 6, the firmware service 212 receives an indication that new firmware is available for installation. By way of example, this indication can be input into the service 212 by a service operator that maintains the service. As noted above, various types of firmware may become available. For instance, the firmware can comprise firmware patches that correct glitches of previous firmware versions, firmware updates that may comprise improved firmware, or specialized firmware that optimizes peripheral device operation in some manner (e.g., firmware that is optimized for graphics printing, firmware that is optimized for high-speed printing, etc.). Such firmware may be intended for execution by the peripheral device itself, or by sub-devices that are used in conjunction with the peripheral device.

Once the firmware service 212 is made aware of the availability of the firmware, the service determines whether to notify any registered users about the new firmware, as indicated in block 602. That determination is made by cross-referencing the new firmware with information contained in the firmware service database 216. Specifically, the firmware service 212 determines whether any peripheral devices for which the firmware is intended that do not already possess the new firmware are registered and, if so, whether the user preferences associated with those peripheral devices indicate that one or more notifications should be transmitted. With reference to decision block 604, if no users are to be notified, the firmware service 212 will await indication that other firmware is available, at which time flow returns back to block 600 and continues in the manner described above.

If, at decision block 604, one or more users are to be notified, flow continues to block 606 at which it is determined what notifications to transmit and to what devices. The notifications can comprise notifications that are transmitted directly to the users, e.g., as email messages sent to user computing devices 106 (FIG. 1), and/or notifications that are transmitted directly to the peripheral devices. In the former case, each email message can comprise a text message as well as a link to a network page (e.g., web page) at which one or more firmware files may be downloaded to one or more peripheral devices, as well as release notes that describe the firmware and what it does. If release notes are included, they can, for example, be attached to the email message as a separate text file.

In the case in which the notifications are to be transmitted directly to the peripheral devices, the notifications received by the peripheral devices can be used to generate notifications that are presented in the peripheral device displays that can be seen by walk-up users of the peripheral devices, notifications that are posted on network pages hosted by the peripheral devices (e.g., by the embedded network servers 318), and/or notifications that are sent to peripheral device users (e.g., administrators) via a suitable transmission medium (e.g., email). With reference to block 608, the one or more notifications are then transmitted by the firmware service to the user(s) and/or peripheral device(s).

In cases in which the notifications are transmitted directly to peripheral device users via email, the email messages may, as noted above, comprise links to network pages (e.g., web pages) at which the new firmware can be downloaded to the peripheral devices. By way of example, these network pages may be hosted by the firmware service 212 and are provided as a means to request such download. In such a case, the user can request that one or more firmware files 218 be downloaded to one or more peripheral devices. The firmware files 218 may comprise, for instance, remote firmware update (RFU) files that are configured for recognition by the peripheral devices' firmware installers 316. When such a file 218 is received by a firmware installer 316, the installer recognizes that the file contains bundled firmware that is to be installed and, therefore, the installer will install the firmware.

FIG. 7 discusses a case in which the firmware availability notification is transmitted directly to a peripheral device. In particular, FIG. 7 describes an example of operation of a peripheral device 104 in receiving such a notification and acting upon it in some manner. Referring now to block 700 of FIG. 7, the peripheral device 104 receives the firmware availability notification. Once the notification is received, the peripheral device 104 determines whether to post and/or transmit a notification, as indicated in block 702. In the former case, the peripheral device 104, and more particularly the embedded network server 318, will post a notification on a network page that the user will see when the peripheral device 104 is accessed via a network browser. The posted notification can describe the nature of the available firmware, and may comprise the firmware release notes. Optionally, the posted notification can further prompt the user to choose to install, or not install, the firmware.

If the peripheral device 104 has been configured to send a related notification to the user, the peripheral device can transmit a message, such as an email message, to the user to notify the user as to the availability of the firmware. Such a message may, again, comprise a link to a network page at which the user can learn about the nature of the available firmware and, if desired, request download of the firmware to the peripheral device 104.

If no such notification is to be posted or transmitted, flow continues down to decision block 706 described below. If, on the other hand, the notification is to be posted and/or transmitted, flow continues to block 704 at which the peripheral device 104 posts and/or transmits a notification to the user. Next, with reference to decision block 706, the peripheral device 104 determines whether to display a notification in the peripheral device display 306. As is apparent from the flow of FIG. 7, such a notification may be provided in addition or in exception to a posted and/or transmitted notification. This notification can comprise a brief indication that firmware is available for installation, or a more detailed description of the firmware depending upon the nature (e.g., size) of the peripheral device display 306 and/or the memory resources of the peripheral device 104. In addition, the displayed notification can enable the user to initiate download of the firmware to the peripheral device 104. In such a case, authorization to initiate such download may be limited to certain individuals (e.g., an administrator) by use of an appropriate security feature, such as password protection.

If no such notification is to be displayed in the peripheral device display 306, flow continues down to decision block 710 described below. However, if a notification is to be displayed on the peripheral device 104, the peripheral device then displays it, as indicated in block 708. Referring next to decision block 710, the peripheral device 104 then determines whether a firmware installation request has been received. This installation request can have been received via a network page hosted by the peripheral device 104 (i.e., by embedded network server 318), or via the control panel if a notification was shown in the peripheral device display 306. In either case, the peripheral device 104 then transmits a download request to the firmware service 212 to request that the service transmit one or more firmware files 218 to the peripheral device, as indicated in block 712.

Returning to FIG. 6, the firmware service 212 next determines whether a firmware request has been received, as indicated in block 610. This request can have been received either from the peripheral device 104 (FIG. 7), or via a network page hosted by the firmware service 212 (e.g., if the user received an email message containing a link to that page). If no such request has been received, no action is required and flow returns to block 600 at which new firmware availability indications may be received by the firmware service 212. However, if one or more requests have been received, the firmware service 212 transmits one or more firmware files 218 to one or more peripheral devices, as indicated in block 612. Again, these files 218 can comprise, for instance, RFU files that are configured for recognition by firmware installers of the peripheral devices.

With reference back to FIG. 7, one or more firmware files 218 are received and installed by the peripheral device 104, as indicated in block 714. Specifically, the firmware installer 318 recognizes the one or more firmware files 218 as containing firmware that is to be installed on the peripheral device 104, and then installs that firmware on the device 104 and/or on the sub-device(s) associated with the peripheral device. At this point, flow for the notification/installation session is terminated.

1. A method for facilitating installation of peripheral device firmware, the method comprising:
transmitting a firmware availability notification;
receiving a firmware download request; and
transmitting a firmware file to a peripheral device for installation on the peripheral device.

2. The method of claim 1, wherein transmitting a firmware availability notification comprises transmitting a notification to the peripheral device.

3. The method of claim 1, wherein transmitting a firmware availability notification comprises transmitting an email message to the user.

4. The method of claim 3, wherein transmitting an email message to a user comprises transmitting a link to a network page at which firmware download can be requested.

5. The method of claim 1, wherein receiving a firmware download request comprises receiving a firmware download request transmitted by a peripheral device.

6. The method of claim 1, wherein transmitting a firmware file comprises transmitting a remote firmware update (RFU) file to the peripheral device.

7. The method of claim 1, further comprising registering a peripheral device with a firmware service and determining whether to transmit a firmware availability notification based upon information that was collected through peripheral device registration.

8. A system for facilitating installation of peripheral device firmware, the system comprising:
means for transmitting a notification to a device indicating that new firmware is available for installation;
means for receiving a firmware download request; and
means for transmitting a firmware file directly to a peripheral device.

9. The system of claim 8, wherein the means for transmitting a notification comprise means for transmitting a notification to a peripheral device.

10. The system of claim 8, wherein the means for transmitting a notification comprise means for transmitting an email message to a user, the email message including a link to a network page at which firmware download can be requested.

11. The system of claim 8, wherein the means for transmitting a firmware file comprise means for transmitting a remote firmware update (RFU) file to the peripheral device.

12. The system of claim 8, further comprising means for registering a peripheral device with a firmware service.

13. A method for facilitating installation of firmware on a peripheral device, the method comprising:
a peripheral device receiving a firmware availability notification; and
the peripheral device providing a related notification to a user.

14. The method of claim 13, wherein the peripheral device providing a related notification to a user comprises the peripheral device posting a notification on a network page using a network server embedded in the peripheral device.

15. The method of claim 13, wherein the peripheral device providing a related notification to a user comprises the peripheral device transmitting a message to a user computing device.

16. The method of claim 13, wherein the peripheral device providing a related notification to a user comprises the peripheral device displaying a notification.

17. The method of claim 13, further comprising the peripheral device receiving a request to install available firmware.

18. The method of claim 17, further comprising the peripheral device transmitting a firmware download request to a firmware service.

19. The method of claim 18, further comprising the peripheral device receiving a firmware file and installing the firmware file on the peripheral device.

20. A system for facilitating installation of firmware on a peripheral device, the system comprising:
means provided on a peripheral device for receiving a notification from a firmware service that new peripheral device firmware is available for download; and
means provided on the peripheral device for providing a related notification to a device user.

21. The system of claim 20, wherein the means for providing a related notification comprise an embedded network server that is configured to post a notification on a network page.

22. The system of claim 20, wherein the means for providing a related notification comprise means for transmitting a message to a user computing device from the peripheral device.

23. The system of claim 20, wherein the means for providing a related notification comprise means for displaying a notification in a display of the peripheral device.

24. The system of claim 20, further comprising means for receiving and installing a firmware file on the peripheral device.

25. A firmware service stored on a computer-readable medium, the service comprising:
logic configured to transmit firmware availability notifications directly to peripheral devices;
logic configured to receive firmware download requests from the peripheral devices; and
logic configured to transmit firmware files to the peripheral devices.

26. The service of claim 25, wherein the logic configured to transmit firmware files comprises logic configured to transmit remote firmware update (RFU) files to the peripheral devices.

27. The service of claim 25, further comprising logic configured to register peripheral devices with the firmware service.

28. The service of claim 27, further comprising logic configured to determine whether to transmit firmware availability notifications based upon collected peripheral device registration information.

29. A peripheral device, comprising:
logic configured to directly receive firmware availability notifications that are transmitted by a firmware service via a network; and
logic configured to provide related notifications to a user.

30. The device of claim 29, wherein the logic configured to provide related notifications comprises an embedded network server that is configured to post notifications on network pages accessible via a network browser.

31. The device of claim 29, wherein the logic configured to provide related notifications comprises logic configured to transmit email messages to a user computing device that indicate that firmware is available for installation.

32. The device of claim 29, further comprising a display and wherein the logic configured to provide related notifications comprises logic configured to present notifications in the display.

33. The device of claim 29, further comprising logic configured to receive a firmware installation request and logic configured to transmit a firmware download request to the firmware service.

34. The device of claim 33, further comprising logic configured to receive and install firmware files.
